(19) United States
(12) Patent Application Publication
(10) Pub. No.: US 2008/0288967 A1
(43) Pub. Date: Nov. 20, 2008

(54) PROCEDURE CALLING METHOD, PROCEDURE CALLING PROGRAM, AND COMPUTER PRODUCT

(75) Inventors: Takahisa SUZUKI, Kawasaki (JP); Hideo Miyake, Kawasaki (JP)

Correspondence Address: ARENT FOX LLP, 1050 CONNECTICUT AVENUE, N.W., SUITE 400, WASHINGTON, DC, 20036, US

(73) Assignee: Fujitsu Limited, Kawasaki (JP)

(21) Appl. No.: 12/184,000

(22) Filed: Jul. 31, 2008

Related U.S. Application Data
(63) Continuation of application No. PCT/JP2006/301532, filed on Jan. 31, 2006.

(51) Int. Cl. G06F 9/46

(52) U.S. Cl. 719/330

(57) ABSTRACT

In a shared-memory multiprocessor having plural processors that share a shared memory, each have an address space that is respectively independent in the shared memory and are configured to be capable of inter-processor communication using a bus, a first processor makes a procedure call to a second processor by specifying an address in the address space of the second processor. In response to the procedure call, by initiating and executing the procedure located at the address specified by the first processor, the second processor initiates the procedure at a high speed.

### BACKGROUND

1. Field

The embodiments discussed herein are directed to procedure calling in a shared-memory multiprocessor.

2. Description of the Related Art

Generally, in a computer system, using plural processors, methods of performing parallel processing by a procedure call include a local procedure calling scheme and a remote procedure calling scheme. FIGS. 10 and 11 are conceptual diagrams of the local procedure calling scheme and the remote procedure calling scheme, respectively. As shown in FIG. 10, the local procedure calling scheme is a method of making the procedure call between a first processor 2 and a second processor 3 that are provided in a common machine (computer) 1 and have a shared-memory 4.

This local procedure calling scheme has an advantage in that communication between the processors 2 and 3 can be performed at a high speed. However, since plural processors 2 and 3 use the same memory area, this scheme has a problem in that as the number of processors increases, conflicts in memory access increase memory access latency and improvements in computer processing efficiency become difficult. As this scheme requires a configuration for controlling coherence of a cache, there is also a problem in that this coherence control mechanism becomes complicated as the number of processors increases.

On the other hand, as shown in FIG. 11, the remote procedure calling scheme is a method of making the procedure call between independent machines 5 and 6 by way of a network 7, e.g., an Ethernet (registered trademark), such as the scheme described by Birrell, Andrew D., et al. in “Implementing Remote Procedure Call”, ACM Transactions on Computer Systems, (U.S.), February 1984, Volume 2, Issue 1, pp. 39-59. In this case, a processor 8 in a client machine 5 uses a memory 9 in the client machine 5. A processor 10 in a server machine 6 uses a memory 11 in the server machine 6. Therefore, the remote procedure calling scheme does not cause the problems of increased memory access latency due to conflicts in memory access and a complicated mechanism for controlling the coherence of the cache, as found with the local procedure calling scheme.

However, in the remote procedure calling scheme, in order for the processor 8 in the client machine 5 to make the procedure call to the processor 10 in the server machine 6, the processor 8 in the client machine 5 must specify the address of the corresponding procedure in the memory 11 of the server machine 6. Since the client machine 5 and the server machine 6 are independent of each other, the processor 8 in the client machine 5 is not capable of knowing the corresponding address in the memory 11 in the server machine 6.

Accordingly, in the conventional remote procedure calling scheme, configuration is such that description about the hardware, such as the memory, is abstracted and the procedure to be called is specified by an identifier such as an ID number. In this case, such as the address space of the memory 11 in the server machine 6 shown in FIG. 12, it is necessary to prepare, at a data area 12 for a server program, a table indicating correspondence between the addresses of procedures 14, 15, 16, and 17 developed in a program area 13 for the server program and identifiers such as the ID numbers. This leads to a problem in that utilization of the memory 11 in the server machine 6 is increased accordingly.

In the remote procedure calling scheme, since communication between the machines 5 and 6 is performed using a network 7, the speed of communication between the processors 8 and 10 is considerably slow as compared with the case of using a local procedure calling scheme. Furthermore, on the server machine 6 side, since it is necessary to search for the address corresponding to the identifier such as the ID number, the procedure initiation processing takes time. This causes a problem, as shown in FIG. 13, of a long initiation overhead from the client machine 5 sending the procedure call until the execution of the corresponding procedure at the server machine 6.

The embodiments were conceived in light of the above and an object of the embodiments is to provide a procedure calling method in a shared-memory multiprocessor, whereby a remote procedure calling scheme is applied for communication between plural processors sharing memory and the procedure calling method is capable of reducing memory utilization in a server machine and of improving procedure initiation processing speed. Another object of the embodiments is to provide a procedure calling program that causes a computer to execute such a procedure calling method and a computer-readable recording medium on which such a program is recorded.

### SUMMARY

It is an aspect of the embodiments discussed herein to provide a procedure calling method in a shared-memory multiprocessor having processors that are capable of inter-processor communication using a bus, share a memory and each have an address space that is respectively independent in the memory, whereby a first processor of the shared-memory multiprocessor makes a procedure call to a second processor thereof includes making the procedure call by the first processor specifying an address in the address space of the second processor; and initiating and executing, by the second processor, a procedure located at the address specified by the first processor.

According to another aspect of the embodiments, a procedure calling method in a shared-memory multiprocessor having processors that are capable of inter-processor communication using a bus, share a memory and each have an address space that is respectively independent in the memory, whereby a first processor of the shared-memory multiprocessor makes a procedure call to a second processor thereof includes specifying, by the first processor, an address in the address space of the second processor; and making the procedure call to the second processor by the first processor.

According to still another aspect of the embodiments, a procedure calling method in a shared-memory multiprocessor having processors that are capable of inter-processor communication using a bus, share a memory and each have an address space that is respectively independent in the memory, whereby a first processor of the shared-memory multiprocessor makes a procedure call to a second processor thereof includes reading, by the second processor, an address in the address space of the second processor and specified by the first processor; initiating, by the second processor, a procedure located at the address specified by the first processor; and executing, by the second processor, the procedure initiated.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a conceptual diagram of a procedure calling method according to the embodiments;

FIG. 2 is a block diagram of essential elements of a hardware configuration according to a first embodiment;

FIG. 3 is a conceptual diagram for explaining software configuration;

FIG. 4 is a flowchart of the procedure calling method according to the first embodiment;

FIG. 5 is a block diagram of essential elements of the hardware configuration according to a second embodiment;

FIG. 6 is a flowchart of the procedure calling method according to the second embodiment;

FIG. 7 is a flowchart of the procedure calling method according to a third embodiment;

FIG. 8 is a block diagram of essential elements of the hardware configuration according to a fourth embodiment;

FIG. 9 is a flowchart of the procedure calling method according to the fourth embodiment;

FIG. 10 is a conceptual diagram of a conventional local procedure calling scheme;

FIG. 11 is a conceptual diagram of a conventional remote procedure calling scheme;

FIG. 12 is a conceptual diagram of a data area and a program area in a memory of a server machine in a conventional remote procedure calling scheme; and

FIG. 13 is a timing diagram concerning procedure initiation in the conventional remote procedure calling scheme.

### DETAILED DESCRIPTION OF THE PREFERRED EMBODIMENTS

With reference to the accompanying drawings, exemplary embodiments are explained in detail below. The present invention is not limited by the embodiments and the multiprocessor in the embodiments includes configurations in which plural processors are provided on one IC chip and in which among plural IC chips, one or more processors is/are provided on each of the IC chips.

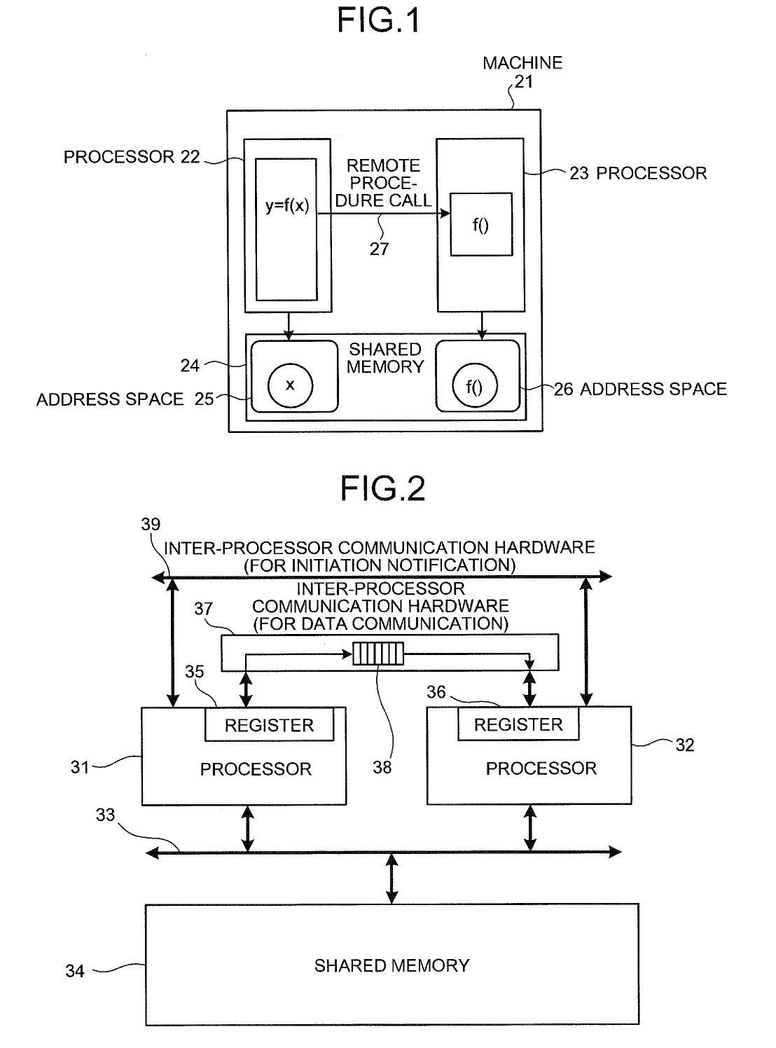

FIG. 1 is a conceptual diagram of the procedure calling method, in a shared-memory multiprocessor, according to the embodiments. As shown in FIG. 1, a first processor 22 and a second processor 23 provided in a machine (computer) 21 physically share the same memory, a shared memory 24. An address space 25 managed by the first processor 22 and an address space 26 managed by the second processor are independent of each other in the shared memory 24.

This configuration enables a procedure call to be made by applying the remote procedure calling method between the first processor 22 and the second processor 23. For such a procedure call, it is not necessary to abstract an address of the memory by an identifier as is required in the conventional remote procedure calling scheme. Therefore, the first processor 22, by specifying an address of the address space 26 managed by the second processor 23, makes the remote procedure call by way of inter-processor communication hardware 27. The use of a bus for the inter-processor communication similarly enhances the speed of the communication between the processors as with a local procedure call.

Since the second processor 23 called by the procedure call is not required to search for the address corresponding to the identifier during procedure initiation processing, the time required for such processing is reduced. The higher communication speed and the shorter time for the procedure initiation processing shortens the initiation overhead from the first processor 22 making the procedure call to the second processor 23 until the second processor 23 initiates execution of the corresponding procedure, thereby enabling high speed initiation of the execution of the remote procedure.

Since a table indicating correspondence between the identifier and the address is not necessary, utilization of the shared memory 24 can be reduced. Furthermore, as the independence of the address spaces 25 and 26 simplifies control of cache memory coherence and control of memory access conflicts, processing efficiency of the computer is enhanced even if the number of processors sharing the same memory is increased to 3 or more.

FIG. 2 is a block diagram of essential elements of the hardware configuration according to the first embodiment. As shown in FIG. 2, a first processor 31 and a second processor 32 are connected to a shared memory 34 by way of a bus 33 and physically share the shared memory 34. The first processor 31 has a register (hereinafter, a transmitting communication register) 35 to which the address of a procedure to be call is written. The second processor 32 has a register (hereinafter, a receiving communication register) 36 to which the address of the procedure called is written.

The transmitting communication register 35 and the receiving communication register 36 are connected to inter-processor communication hardware 37 for data communication using a bus. This inter-processor communication hardware 37 for data communication has queued data buffers 38 provided therein and is designed so that plural data items can be communicated between the transmitting communication register 35 and the receiving communication register 36. The first processor 31 and the second processor 32 are connected to inter-processor communication hardware 39 for initiation notification using a bus.

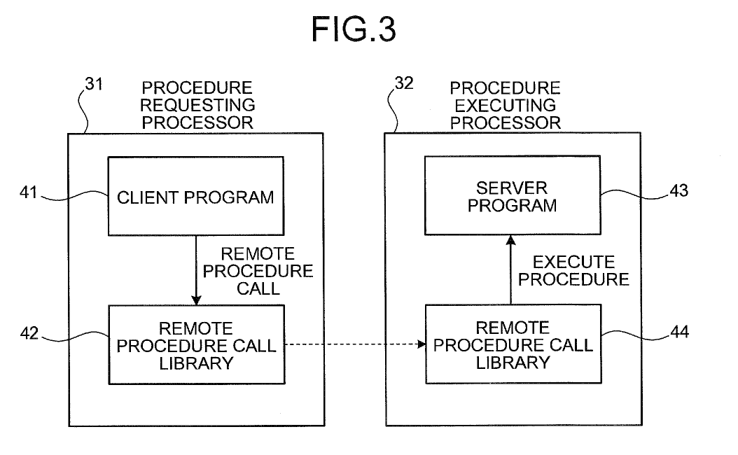

FIG. 3 is a conceptual diagram for explaining software configuration. As shown in FIG. 3, a procedure calling processor, namely, the first processor 31 in the embodiment above, has a client program 41 and a library for remote procedure calling (remote-procedure-call library) 42. Meanwhile, the second processor 32, as a procedure executing processor, has a server program 43 and a library for remote procedure calling (remote-procedure-call library) 44. In the first processor 31, when the client program 41 requests the remote-procedure-call library 42 to make the remote procedure call, the procedure requested by the remote-procedure-call library 42 is executed in the second processor 32.

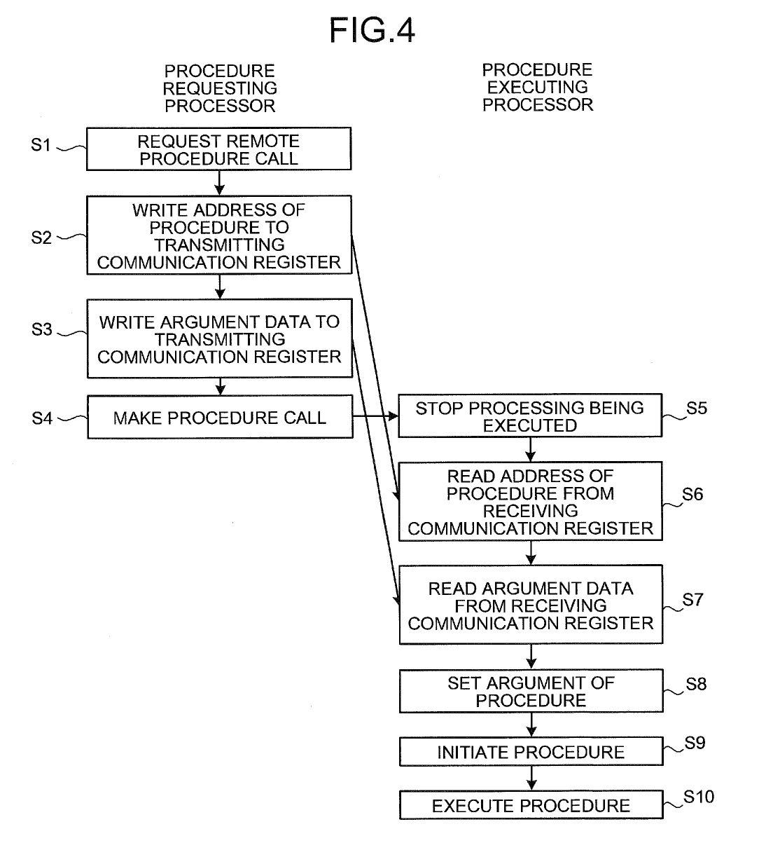

FIG. 4 is a flowchart of the procedure calling method according to the first embodiment. As shown in FIG. 4, in the first processor 31, the client program 41 requests the remote-procedure-call library 42 to make the remote procedure call (step S1). As a result, in the first processor 31, the remote-procedure-call library 42 writes the address of the requested procedure in the transmitting communication register 35 (step S2). Next, in the first processor 31, the remote-procedure-call library 42 writes, in the transmitting communication register 35, argument data for the procedure and received from the client program 41 (step S3).

Contents written to the transmitting communication register 35 are sequentially stored in data buffers 38 provided in the inter-processor communication hardware 37 for data communication. The address firstly stored in the data buffers 38 is transferred to and written to the receiving communication register 36 of the second processor 32. Then, the remote-procedure-call library 42 in the first processor 31 makes the procedure call to the second processor 32 (step S4).

The second processor 32, upon receipt of the procedure call from the first processor 31, stops the processing being executed (step S5). Then, the second processor 32 reads the address of the procedure from the receiving communication register 36 (step S6) and by doing so, the argument data stored in the data buffers 38 subsequent to the address is transferred to and written to the receiving communication register 36 of the second processor 32. The second processor 32 reads the argument data of the procedure from the receiving communication register 36 (step S7). By recursively performing this process, the second processor 32 reads all of the argument data. The second processor 32 sets the argument data read as arguments for the procedure (step S8), performs procedure initiation processing (step S9), and executes the procedure (step S10).

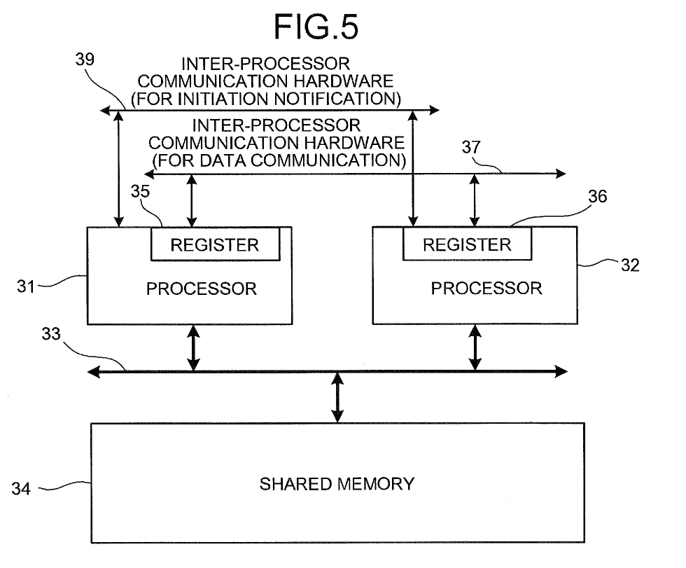

FIG. 5 is a block diagram of essential elements of the hardware configuration according to the second embodiment. As shown in FIG. 5, the data buffers 38 are not provided in the inter-processor communication hardware 37 for data communication in the second embodiment. Therefore, in the second embodiment, after the second processor 32 reads the data from the receiving communication register 36, the next data is written to the transmitting communication register 35 of the first processor 31. Since other aspects of the hardware and software configurations are identical to those of the first embodiment, description thereof is omitted.

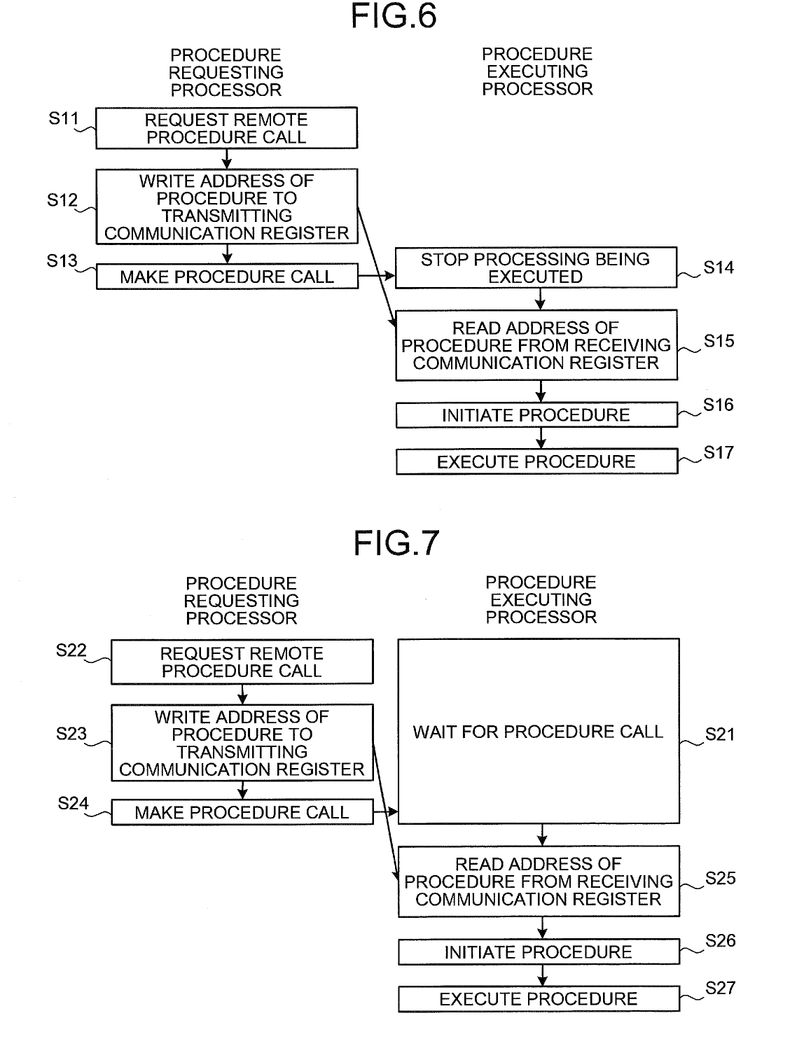

FIG. 6 is a flowchart of the procedure calling method according to the second embodiment. As shown in FIG. 6, in the first processor 31, the client program 41 requests the remote-procedure-call library 42 to make the remote procedure call (step S11). As a result, in the first processor 31, the remote-procedure-call library 42 writes the address of the requested procedure to the transmitting communication register 35 (step S12). The address written to the transmitting communication register 35 is transferred to and written to the receiving communication register 36 of the second processor 32.

The remote-procedure-call library 42 of the first processor 31 makes the procedure call to the second processor 32 (step S13). The second processor 32, upon receipt of the procedure call from the first processor 31, stops the processing being executed (step S14). Then, the second processor 32 reads the address of the procedure from the receiving communication register 36 (step S15). The second processor 32 performs processing to initiate the procedure located at the address read (step S16) and executes the procedure (step S17).

As the hardware configuration and the software configuration according to the third embodiment are identical to that of the second embodiment, description thereof is omitted. FIG. 7 is a flowchart of the procedure calling method according to the third embodiment. As shown in FIG. 7, the second processor 32 continuously waits for the procedure call from the first processor 31 (step S21). In this state, in the first processor 31, the client program 41 requests the remote-procedure-call library 42 to make the remote procedure call (step S22). As a result, in the first processor 31, the remote-procedure-call library 42 writes the address of the requested procedure to the transmitting communication register 35 (step S23). The address written to the transmitting communication register 35 is transferred to and written to the receiving communication register 36 of the second processor 32.

The remote-procedure-call library 42 of the first processor 31 makes the procedure call to the second processor 32 of the procedure call (step S24). The second processor 32, upon receipt of the procedure call from the first processor 31, releases the procedure-call waiting state and reads the address of the procedure from the receiving communication register 36 (step S25). The second processor 32 performs processing to initiate the procedure located at the address read (step S26) and executes the procedure (step S27).

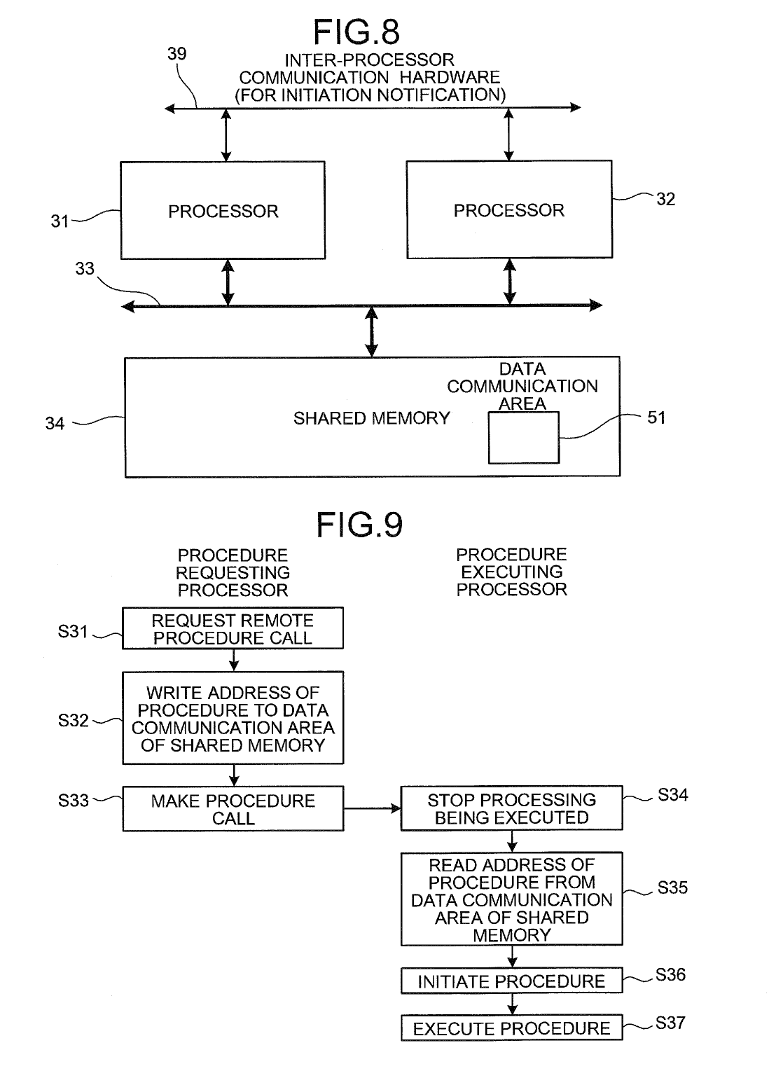

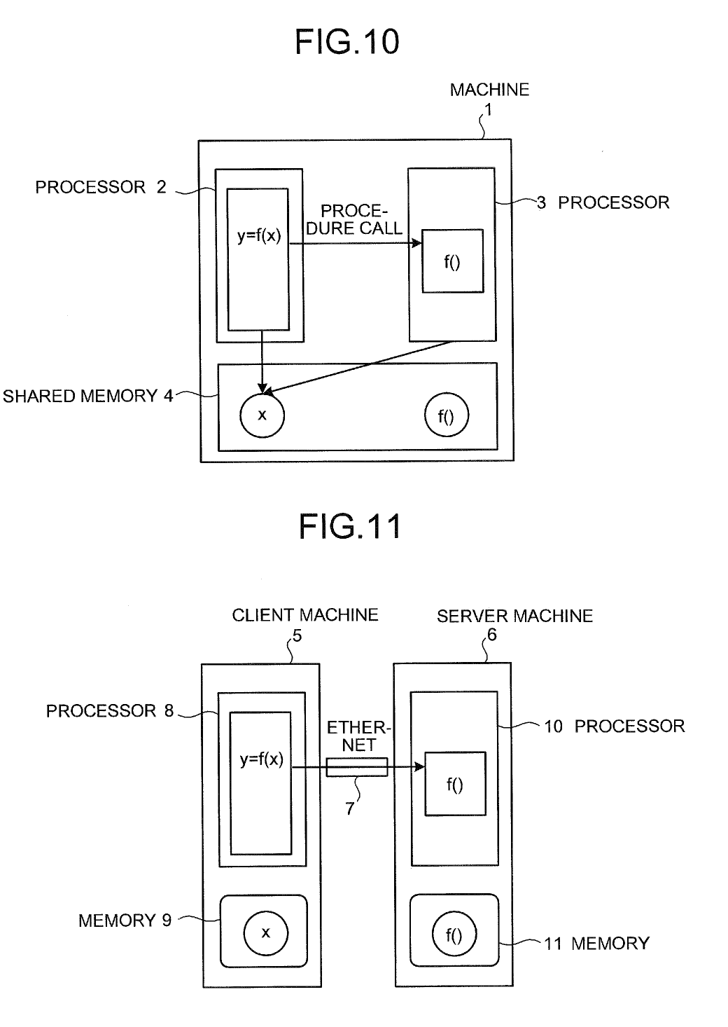

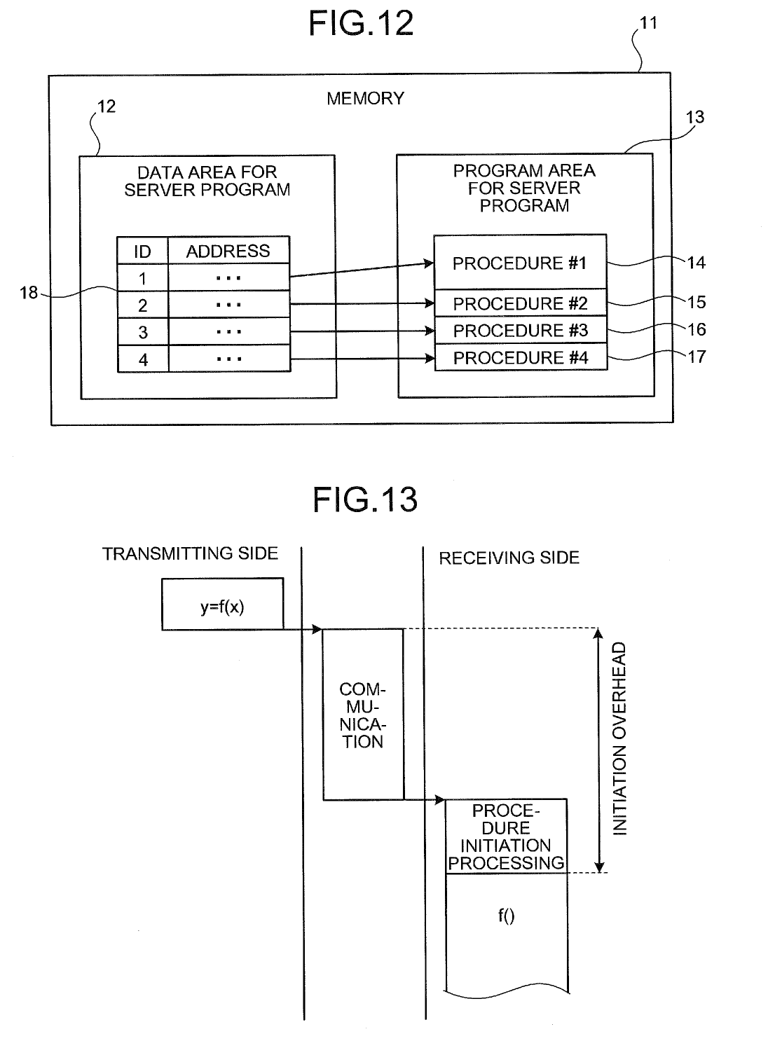

FIG. 8 is a block diagram of essential elements of the hardware configuration according to the fourth embodiment. As shown in FIG. 8, the inter-processor communication 37 for data communication is not provided in the fourth embodiment. Instead, a data communication area 51 to be used for the data communication between the processors is provided in the shared memory 34 shared by the first processor 31 and the second processor 32. Therefore, in the fourth embodiment, the first processor 31 writes the address of the procedure to be call to this data communication area 51 and the second processor 32 reads the address from this data communication area 51. Since other aspects of the hardware and software configurations are identical to those of the second embodiment, description thereof is omitted.

FIG. 9 is a flowchart of the procedure calling method according to the fourth embodiment. As shown in FIG. 9, in the first processor 31, the client program 41 requests the remote-procedure-call library 42 to make the remote procedure call (step S31). As a result, in the first processor 31, the remote-procedure-call library 42 writes the address of the requested procedure to the data communication area 51 of the shared memory 34 (step S32).

The remote-procedure-call library 42 of the first processor 31 makes the procedure call to the second processor 32 (step S33). The second processor 32, upon receipt of the procedure call from the first processor 31, stops the processing being executed (step S34) and reads the address of the procedure from the data communication area 51 of the shared memory 34 (step S35). The second processor 32 performs processing to initiate the procedure located at the address read (step S36) and executes the procedure (step S37).

According to the embodiments, a processor called by the procedure call can directly initiate the procedure located at the address specified by the calling processor, thereby enabling a shortening of the time required for the procedure initiation processing and high speed initiation of the procedure, without a need for processing to search for the address corresponding to an identifier as is required in the procedure initiation processing of the conventional remote procedure calling scheme. Also, the embodiments, which do not require a table indicating correspondence between the address of the procedure and the identifier, enable a reduction in memory utilization.

Although embodiment has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A procedure calling method in a shared-memory multiprocessor having processors that are capable of inter-processor communication using a bus, share a memory and each have an address space that is respectively independent in the memory, the procedure calling method whereby a first processor of the shared-memory multiprocessor makes a procedure call to a second processor thereof and comprising:
making the procedure call by the first processor specifying an address in the address space of the second processor; and
initiating and executing, by the second processor, a procedure located at the address specified by the first processor.

2. The procedure calling method according to claim 1, further comprising:
stopping, by the second processor and upon receipt of the procedure call from the first processor, processing being executed; and
starting, by the second processor, processing to execute the procedure called by the first processor.

3. The procedure calling method according to claim 1, further comprising:
waiting, by the second processor, for the procedure call to be sent; and
starting, by the second processor and upon receipt of the procedure call from the first processor, processing to execute the procedure called by the first processor.

4. The procedure calling method according to claim 1, further comprising:
writing, by the first processor, the address to a register in the first processor; and
reading, by the second processor, the address transferred from the register in the first processor by way of the inter-processor communication and written to a register in the second processor.

5. The procedure calling method according to claim 1, further comprising:
writing, by the first processor, the address to a data communication area that is in the memory and shared with the second processor; and
reading, by the second processor, the address written by the first processor from the data communication area.

6. A procedure calling method in a shared-memory multiprocessor having processors that are capable of inter-processor communication using a bus, share a memory and each have an address space that is respectively independent in the memory, the procedure calling method whereby a first processor of the shared-memory multiprocessor makes a procedure call to a second processor thereof and comprising:
specifying, by the first processor, an address in the address space of the second processor; and
making the procedure call to the second processor by the first processor.

7. A procedure calling method in a shared-memory multiprocessor having processors that are capable of inter-processor communication using a bus, share a memory and each have an address space that is respectively independent in the memory, the procedure calling method whereby a first processor of the shared-memory multiprocessor makes a procedure call to a second processor thereof and comprising:
reading, by the second processor, an address in the address space of the second processor and specified by the first processor;
initiating, by the second processor, a procedure located at the address specified by the first processor; and
executing, by the second processor, the procedure initiated.

8. The procedure calling method according to claim 7, further comprising:
stopping, by the second processor and upon receipt of the procedure call from the first processor, processing being executed; and
starting, by the second processor, processing to execute the procedure called by the first processor.

9. The procedure calling method according to claim 7, further comprising:
waiting, by the second processor, for the procedure call to be sent; and
starting, by the second processor and upon receipt of the procedure call from the first processor, processing to execute the procedure called by the first processor.
